(19) United States
(12) Patent Application Publication
(10) Pub. No.: US 2007/0293795 A1
(43) Pub. Date: Dec. 20, 2007

(54) Skin Abrasion Apparatus and Method

(76) Inventor: Timothy Carroll, Maineville, OH (US)

Correspondence Address: HASSE & NESBITT LLC, 8837 CHAPEL SQUARE DRIVE, SUITE C, CINCINNATI, OH, 45249, UNITED STATES, 513-229-0383, 513-229-0683

(21) Appl. No.: 11/697,536

(22) Filed: Apr. 6, 2007

(51) Int. Cl. A61H 1/00

(52) U.S. Cl. 601/138; 601/17; 601/97; 601/101; 601/112; 606/131

(57) ABSTRACT

A handheld apparatus including an internal motor and a removable treatment paddle. The removable treatment paddle is designed for connection with the internal motor, and typically has a first surface and a second surface. The first surface typically includes an abrasive material formed into or attached to the surface for skin exfoliation, and the second surface is typically a relatively less abrasive surface than the first surface, for aid in infusing at least one topical active into the skin after treatment with the first surface. The improved device also includes a multi-sided handpiece having a plurality of flat sides for ease of handling, and at least one ventilation hole to prevent overheating of the device during operation. The handpiece can also include a fan for proper ventilation through the ventilation holes. In one embodiment, the handpiece includes an insulating sleeve to protect the user's hand from the heat generated from the device, as well as to provide an improved gripping surface for the handpiece and to decrease the level of noise production from the handpiece.

### FIELD OF THE INVENTION

The present invention relates in general to skin treatment and skin exfoliation and in particular to an improved apparatus and method for abrading, cleaning and rejuvenating the skin.

### BACKGROUND OF THE INVENTION

Recently, dermatologists and skin care specialists have been developing methods for the prevention and treatment of aging skin. Methods of treating sun damaged or aging skin include drug treatments with retinoids, anti-oxidants, biologicals and other compositions. Mechanical treatments using devices or materials are also currently available for ablative treatments, which remove tissue from the surface of the skin through to the epidermis and in some cases to the dermis layers of the skin, and non-ablative treatments, which include dermal stimulation and minimally ablative treatments which remove tissue from the stratum corneum layer of skin. Some examples of aggressive ablative methods that are used to even out skin color, lines and remove pre-cancerous lesions by removing portions of the epidermis and/or dermis include dermabrasion, in which a dermabrader (a rapidly rotating device) is used to remove the upper layers of the skin, laser abrasion or laser resurfacing using either CO2 laser or an erbium YAG laser, which burns the outer layer of the skin with a controlled second degree burn, and phenol or trichloroacetic acid peels. Each of these aggressive ablative methods can result in skin damage. With dermabrasion and laser abrasion, the skin will remain red or pink for weeks to months, and with peels, depending upon the type of peel, the skin will look red for one week to months.

Thus, although recent advances in laser and chemical treatments have been successful in improving the appearance of human skin, these methods are rather labor intensive and can be traumatic. Professional skin treatment procedures are also typically expensive and time consuming. For example, microdermabrasion procedures require a patient to travel to a facility and undergo treatment by certified professionals utilizing specialized equipment. Such sessions involve pneumatic abrasion of the skin with microscopic crystals, such as aluminum oxide or magnesium oxide.

As an alternative to professional treatment sessions, home treatment typically involves facial scrubs or microdermabrasion creams applied by hand. Although time and money are saved, the quality of the treatment and the degree of skin abrasion are sacrificed. Some commercially available products include those wherein a vibrating or spinning foam pad is used to apply cream to the face. However, typically the foam pad absorbs the cream and becomes clogged, wasting the expensive cream. In addition, the foam pad is typically highly resilient and pliant, so that a user typically needs to exert substantial pressure in attempting to effect abrasion. This pressure increases the friction between the pad and the skin, thereby generating heat and causing skin irritation.

Less aggressive methods for superficial exfoliation have been developed which include superficial chemical peels, which use alpha hydroxyacids found in fruits and other foods and microdermabrasion which consist of a machine which blasts the skin with very fine particulate matter. These less aggressive methods also result in skin redness and require multiple applications.

The prior art includes various patents disclosing efforts to improve the science of skin rejuvenation. U.S. Pat. No. 6,645,184 to Zelickson et al. discloses a method and apparatus for rejuvenating the skin which includes a handheld device that uses a combination of an adhesive surface, such as tape, and a vibratory motion applied to the skin. The device generates motion which is imparted to an attachment component having an abrasive surface such as tape for placement on the skin surface. The combination of a buffing-type motion and the abrasive surface of the device, when applied to the skin surface, provides a rejuvenating effect for aging skin.

U.S. Patent Application Publication Nos. 2004/0236291 and 2005/0143754, also to Zelickson et al., disclose a skin abrasion apparatus and method using a handheld device with removable treatment paddles that are able to be put into vibratory motion by an internal motion generator within the handheld device. The treatment paddles have a generally curved abrasive surface with an abrasive material formed in or on one side for cleaning, abrasion or polishing of the skin to facilitate removal of tissue.

U.S. Pat. No. 6,641,591 to Shadduck discloses a hand-held instrument for controlled removal of epidermal layers having a working end for abrading the skin surface. The instrument includes a vacuum source for aspirating skin debris from the skin surface after debridement, and also a means for introducing abrasive crystals to the surface of the skin.

U.S. Pat. No. 7,044,938 to La Bianco et al. discloses an apparatus for skin treatment using abrasion lotion and a motorized applicator having a surface that rotates when in use to exfoliate the skin and to impress the abrasion lotion into the skin surface. The rotating applicator surface includes a plurality of bosses with channels in between, the bosses designed to urge and push the abrasion lotion upon the skin.

While the above inventions may be useful for their intended purposes, a continuing need exists in the art for methods and apparatus for effectively treating and exfoliating the skin that may be utilized economically and outside of a professional facility.

### SUMMARY OF THE INVENTION

The present invention relates to an apparatus which provides effective and easy removal of upper skin debris resulting in less redness and edema than microdermabrasion. With proper patient education and performance, treatments can be carried out by the individual, obviating the need to visit a professional skin care specialist for treatment.

A first aspect of the invention provides an apparatus for rejuvenating the skin, comprising: (a) a handle unit comprising an internal motor, at least one ventilation hole for preventing overheating of the motor during operation, and a plurality of flat sides for facile gripping of the handle unit by a user; and (b) a treatment paddle adapted to be partially inserted at a distal end of the handle unit, wherein the distal end of the handle unit includes wall portions defining a connection aperture for connecting the treatment paddle thereto, and wherein the internal motor is adapted to impart motion to the connected treatment paddle.

A second aspect of the invention provides a method of using an apparatus for rejuvenating the skin, comprising the steps of: (a) assessing the skin to be rejuvenated; (b) providing a treatment paddle comprising: (i) a first surface having an abrasive surface formed in or attached thereto for abrading the skin; and (ii) a second surface for aid in infusing at least one topical active into the skin after treatment with the first surface; (c) connecting the treatment paddle to a handle unit of the apparatus, the handle unit comprising (i) an internal motor for imparting motion to the treatment paddle; (ii) a distal end having wall portions defining a connection aperture for connecting the treatment paddle thereto; (iii) at least one ventilation hole to prevent overheating thereof during operation; and (iv) a plurality of flat sides for facile gripping of the handle unit by a user; and (d) operating the apparatus while one of the surfaces of the treatment paddle is in contact with the skin to be rejuvenated, so that the treatment paddle is in moving contact with the skin and provides restructuring and regeneration of skin.

A third aspect of the invention provides an apparatus for rejuvenating the skin, comprising: (a) a handle unit comprising an internal motor, at least one ventilation hole for preventing overheating of the motor during operation, and a plurality of flat sides for facile gripping of the handle unit by a user; (b) a base unit configured to provide power to the internal motor of the handle unit, the base unit comprising at least one power control button adapted for starting and stopping the internal motor of the handle unit; and (c) a treatment paddle comprising a first portion for insertion into the connection aperture; and a second portion including a first surface and a second surface, the first surface having an abrasive surface formed in or attached thereto for abrading the skin, the second surface having a surface for aid in infusing at least one topical active into the skin after treatment with the first surface, wherein the treatment paddle is adapted to be partially inserted at a distal end of the handle unit, wherein the distal end of the handle unit includes wall portions defining a connection aperture for connecting the treatment paddle thereto, and wherein the internal motor is adapted to impart motion to the connected treatment paddle.

The handpiece can also include an internal fan for providing improved ventilation through the ventilation holes. In one embodiment, the handpiece includes an insulating sleeve, typically made of foam rubber or corrugated foam, to protect the user's hand from the heat generated from the device, as well as to provide an improved grip for the handpiece and to decrease the level of noise production from the handpiece.

The nature and advantages of the present invention will be more fully appreciated from the following drawings, detailed description and claims.

### BRIEF DESCRIPTION OF THE DRAWINGS

The accompanying drawings illustrate embodiments of the invention and, together with a general description of the invention given above, and the detailed description given below, serve to explain the principles of the invention.

FIG. 1 is a perspective view of one embodiment of a handle unit and treatment paddle of the invention.

FIG. 2 is a perspective view of the proximal end of the handle unit of FIG. 1.

FIG. 3 is a perspective view of the handle unit of FIG. 1 as it sits in a charging base.

FIG. 4 is a plan view of one embodiment of a treatment paddle of the invention.

FIG. 5 is a sectional view of the treatment paddle of FIG. 4 taken along line 5-5.

FIG. 6 is a perspective view of the proximal end of one embodiment of another handle unit of the invention.

FIG. 7 is a perspective view of one embodiment of the apparatus of the invention, including the handle unit of FIG. 6, a treatment paddle and a base unit.

### DETAILED DESCRIPTION OF THE INVENTION

As used herein, the term “active” or “topical active” is defined as and active ingredient or material. As a non-limiting example, an active such as topical moisturizer or a topical local anesthetic can be applied to the skin via a treatment surface of the treatment paddle of the apparatus.

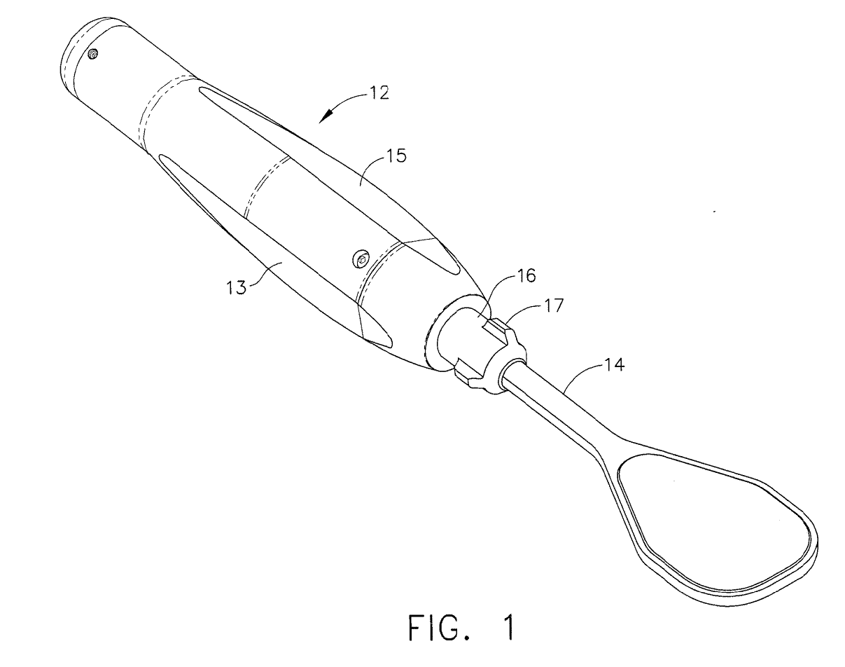

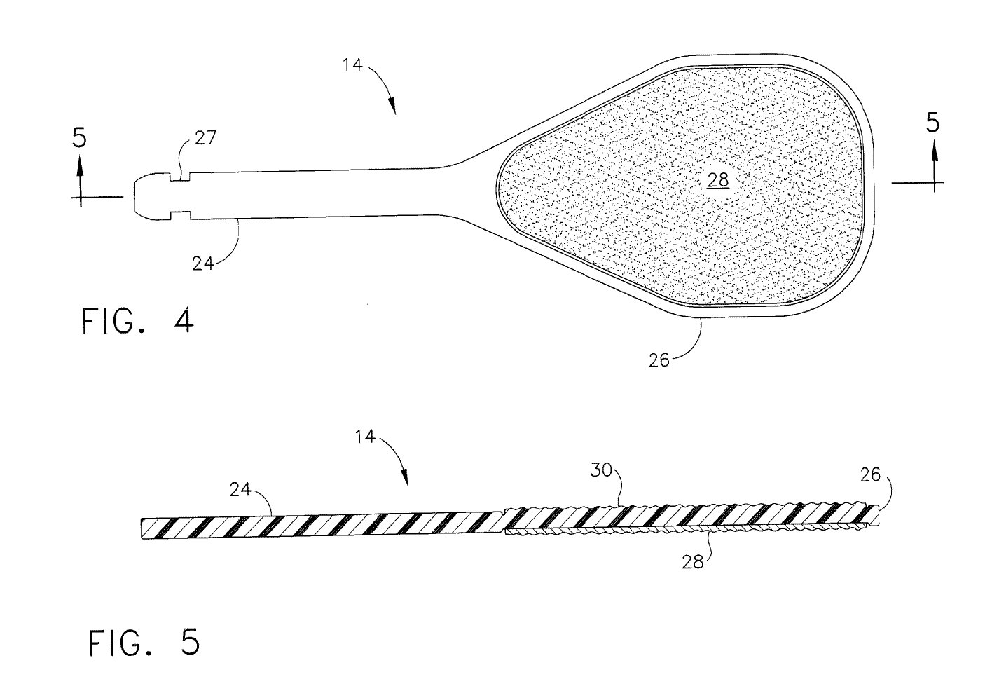

FIG. 1 shows the distal end of one embodiment of the handle unit 12 of the invention. As illustrated, the handle unit 12 is an improvement over the prior art because it includes a multi-sided, ergonomic gripping surface having a plurality of flat sides 13, 15 (and a third, not visible in this view) for ease of handling. These flat sides 13, 15 may have various sizes and shapes, and need not be perfectly flat. The handle unit 12 is configured to cause or impart motion to an applicator tip or treatment paddle 14, which is connected to the distal end of the handle unit 12 through a connection element 16. The treatment paddle 14 is typically removable and reconfigurable, as desired, and is typically in the form of an insertable attachment (see FIG. 4) which is tightened onto the distal end of the handle unit 12 via the connection element 16. The connection element 16 typically includes projections 17 to aid in tightening the paddle 14 onto the handle unit 12. In another embodiment (not shown), the treatment paddle can be permanently attached to the handle unit, or else it can be configured to be screwed onto the handle unit.

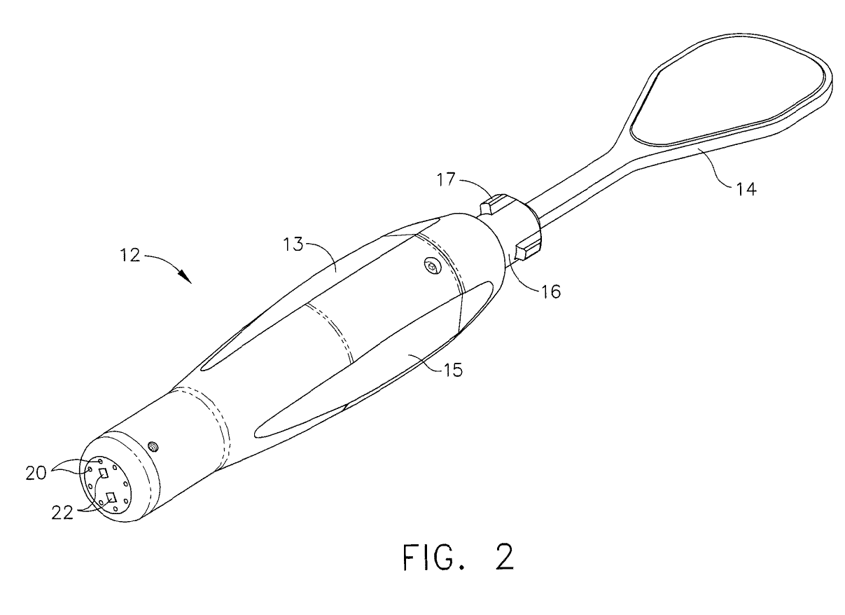

The handle unit 12 typically includes an internal motion generator, or motor, generally of a conventional type similar to that found in mechanical or electrical toothbrush mechanisms, with a capability of causing or imparting reciprocating or circular motion to the applicator tip or treatment paddle 14. As illustrated in FIG. 2, the handle unit 12 also includes an improvement over the prior art by having at least one, and typically a plurality of ventilation holes 20, which serves to prevent overheating of the internal motor during operation. In the embodiment shown, eight ventilation holes 20 surround an entry point 22 for a power source such as an electrical cord or plug. The holes 20 provide increased ventilation so that the apparatus does not overheat, which has been a problem with prior art devices. Of course, the number, size and shape of the ventilation holes can be varied. Each of the ventilation holes 20 are typically at least about 0.5 mm² in area, ranging from about 0.5 mm² and about 300 mm² in area. The total surface area provided by the ventilation holes is at least about 3 mm², typically at least about 5 mm², more typically at least about 10 mm², but it is anticipated that the total ventilation area provided can be very large, such that the total ventilation area provided by the ventilation holes ranges between about 3 mm² and about 3000 mm², more typically from about 5 mm² and about 2500 mm², e.g. from about 10 mm² and about 2000 mm². In one embodiment the total ventilation area provided is about 15 mm². In one embodiment the handle unit 12 also includes an internal fan for providing increased ventilation through the ventilation holes 20.

The handle unit 12 can further be covered with an insulating sleeve (not shown) to protect the user's hand from the heat generated from the handle 12. The insulating sleeve can be made of materials which decrease the level of noise production coming from the handle's internal motor, which typically can operate at speeds of between 1,000 rpm and about 12,000 rpm, more typically at about 8,800 rpm. The insulating sleeve can also be made of a material which provides an improved gripping surface for the handle unit, and is typically made of foam rubber or corrugated foam. The handle unit can also include an on/off button (not shown) for starting and stopping the internal motor.

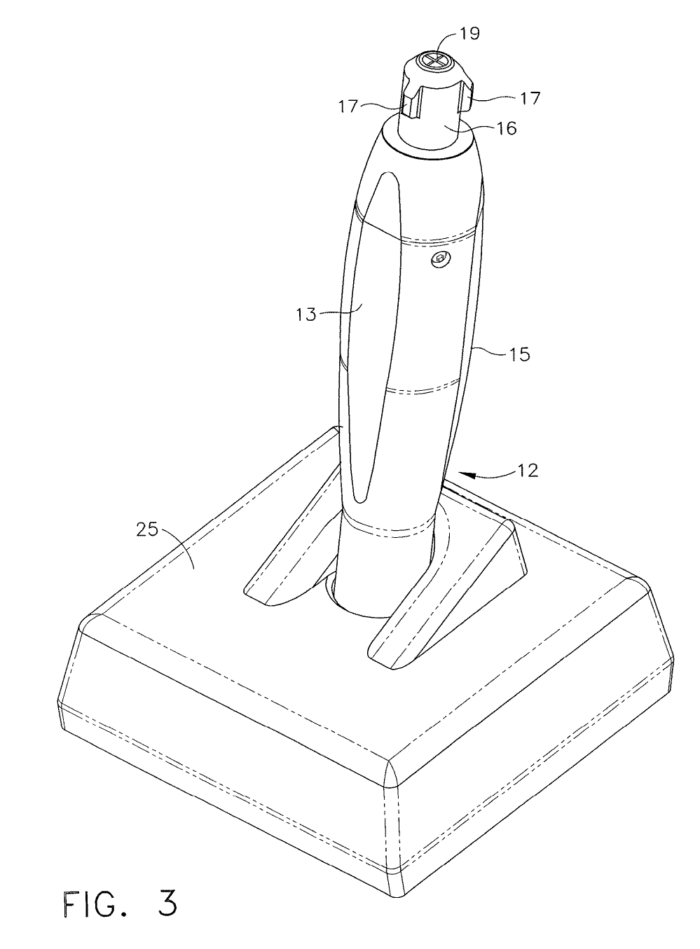

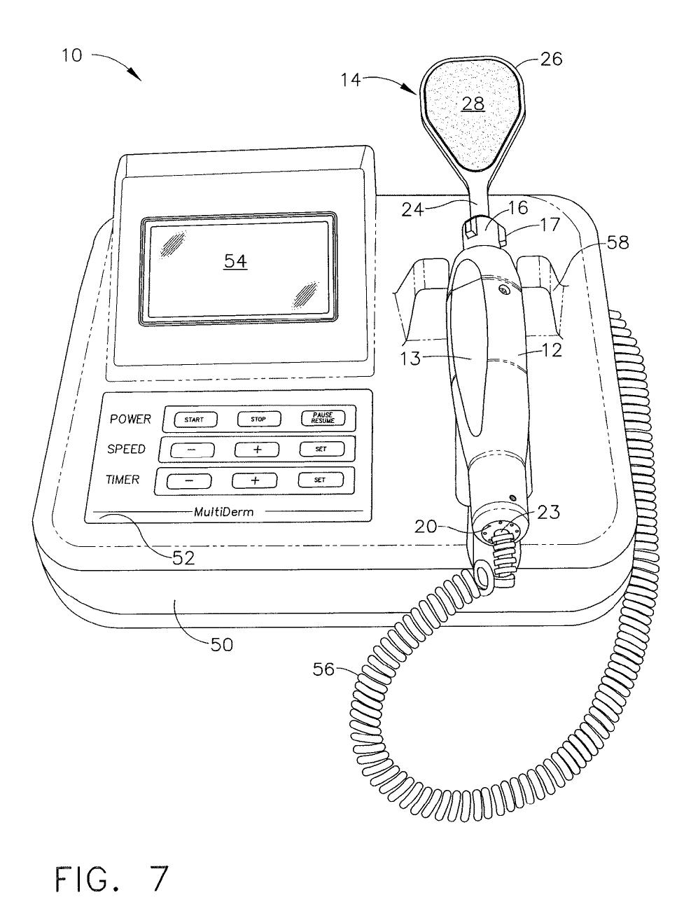

FIG. 3 illustrates the handle unit 12 as it sits in a recharging base 25 which has a power element adapted to connect with connectors at the entry point 22 of the handle unit 12. In this embodiment, the handle unit 12 includes an internal rechargeable battery (or batteries) for operating the internal motor, and the base unit 25 is configured to recharge the battery within the handle unit 12. In the embodiment shown, the handle unit 12 is charged in the receptacle of the base unit 25 prior to use, and the base unit 25 is typically connected to an external power source such as an electrical outlet (not shown). After charging in the base unit 25, the handle unit 12 can then be removed from the base unit for cordless functioning. Another embodiment of the invention employs an electrical cord that can be either plugged into or hardwired to the base unit for powering the handle unit (see FIG. 7), rather than using rechargeable batteries.

Alternatively, the charging base 25 for the rechargeable handle unit can include a plurality of receptacles for charging a plurality of cordless handle units, each receptacle adapted to connect with the entry point 22 of the handle unit 12 that will recharge the rechargeable battery therein. If the charging base has such a plurality of receptacles, it can thus be adapted to be used with multiple handheld devices that are used for skin treatment by professionals in an office setting. Additionally, supplementary handheld devices with additional treatment modalities that may be adapted for use in a total skin care program could be included with the same recharging base. Such devices may include, for example, a transcutaneous electrical nerve stimulator adapted for facial stimulation, an ultrasound device adapted for stimulation of skin at about 20-30 KHz, a laser for skin resurfacing, and/or a non-coherent light device for biostimulation.

As illustrated in FIG. 3, the distal portion of the handle unit 12 includes a connection aperture 19 within the connection element 16. The connection aperture 19 includes wall portions that are movable upon turning of the connection element 16 about its axis. A first portion (24, see FIG. 4) of the treatment paddle fits into the connection aperture 19, and the connection element 16 is then turned (the turning aided via projections 17) so that the wall portions are tightened around the inserted portion of the paddle 14 as it sits within the connection aperture 19.

FIG. 4 illustrates one embodiment of a treatment paddle 14 of the invention. The treatment paddle 14 includes an elongated first portion 24 that is inserted into the connection element (16, FIGS. 1-3), and a flat, paddle-like second portion 26 that is used for skin rejuvenation. The first portion 24 typically includes a notch 27 which is adapted to fit within the connection aperture 19 (see FIG. 3) of the connection element 16 prior to tightening of the wall portions around the paddle 14. The second portion 26 typically includes two surfaces, a first surface 28 and a second surface 30 (see FIG. 5), and can be of various shapes and sizes to accommodate facial features to be treated. As a non-limiting example, the distal end of the second portion 26 can be oval shaped, circular, rectangular, or square (as shown), and typically measures from between about 4 cm² and about 25 cm² in total treating surface area. However, it is anticipated that a very large treatment paddle can be used with the handle piece to treat large areas of the body, such that the treatment paddle can be as large as about 250 cm².

As illustrated in FIG. 5, the first surface 28 of the second portion 26 of the treatment paddle 14 includes an abrasive material formed in or attached thereto, and the second surface 30 is typically flatter and relatively featureless as compared to the first surface 28, yet typically still having some rugosities or folds on its surface. Typically the abrasive material of the first surface 28 is chosen for its ability to clean, abrade, and buff the skin surface as it moves over the user's skin, and the second surface 30 is adapted for infusing topical actives into the skin after treatment with the first surface 28. Representative topical actives can include topical moisturizers, cleansers, peel agents, toner, buffing material, polishing material, medicaments, or topical anesthetics.

Typically the abrasive material of the first surface 28 is chosen for its ability to clean, abrade, and polish the skin when moved over the skin surface. The abrasive material of the first surface 28 may be an abrasive element such as sand, aluminum oxide, silica, or a metallic material into which a pattern has been etched or stamped, such as metallic materials like gold, silver or platinum, or crystal particles such as glass, sapphire or alexandrite. However, the first surface 28 can be made of any type of material, including rubber, paper, etc., so long as the material has an abrasive quality to it. The abrasive material for the first surface 28 may be etched, stamped or otherwise formed as part of the treatment paddle surface or it may be a thin insert of metal, fabric, plastic or rubber film onto which the abrasive pattern has been etched, stamped or affixed and then adhered to the surface of the treatment paddle using any known adhesive.

The material of the second surface 30 is typically made of the same materials as the treatment paddle 14 itself, which is typically any type of sturdy material that is not prone to break at stress points therein. Further, compared to the prior art, the second portion 26 of the paddle 14 is typically flat, rather than curved, as can be most easily seen in FIG. 5, making it easier to apply the surfaces to all portions of the face. As can be appreciated in viewing FIG. 5, both surfaces 28, 30 of the treatment paddle are configured to extend beyond the surface of the first and second portions 24, 26 of the paddle, so that the treatment surfaces 28, 30 more easily make contact with the skin during treatment.

In operation, a user first assesses the skin to be rejuvenated, determining the proper shape and abrasive material for the treatment paddle to use on the skin. Typically a variety of treatment paddles 14 are available for use, each paddle having a second portion 26 with a different size, shape and abrasive first surface 28. Next, the chosen treatment paddle 14 is inserted into the handle unit 12 of the apparatus, and the handle unit 12 is held by the user while one of the surfaces 28, 30 of the second portion 26 of the treatment paddle 14 is pressed into moving contact with the skin surface. The user can operate the motor to impart motion to the treatment paddle 14 via an activation means such as, for example, an on/off button (See FIG. 7). Following activation, the treatment paddle 14 is set into motion in either a reciprocating or circular fashion so as to affect the appropriate buffing, polishing, restructuring and regeneration of the user's skin. For example, following abrasion by the abrasive material of the first surface 28, the gripping handle 12 with the treatment paddle 14 attached thereto is turned around so that the second surface 30 can be used to apply an active to the skin. Alternatively, the treatment paddle 14 can be removed from the connection element 16 and flipped over and then reinserted into the handle 12 to expose the second surface 30.

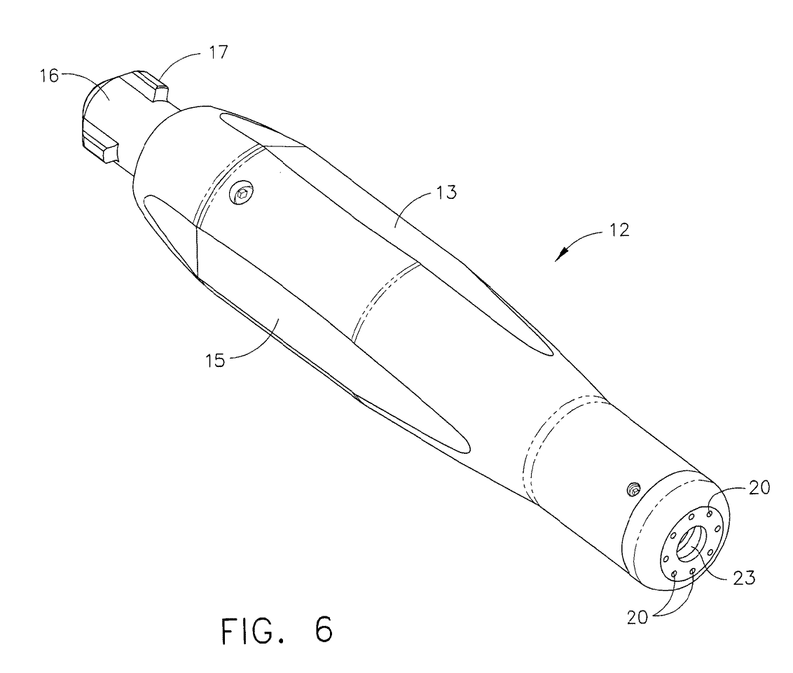

The handle unit 12 of the invention can be battery powered and cordless, as shown in FIG. 3, or it can be powered by an external power source via an electrical cord that can be plugged into or hardwired to the handle unit. FIG. 6 illustrates one embodiment of the handle unit 12 having an entry point 23 adapted to accommodate a cylindrical end of a cord or plug. As can be seen, the handle unit 12 includes multiple flat sides 13, 15 around its circumference for ease in handling, a connection element 16 with projections 17 to aid in tightening the treatment paddle onto the handle unit 12, and a plurality of ventilation holes 20 surrounding the entry point 23 for the cord. As noted above, the handle unit typically includes an internal motor for generating motion for the treatment paddle, and an internal fan can be included to aid in venting heat from the motor through the ventilation holes 20. The handle unit 12 of FIG. 6 is next shown in FIG. 7 as it will appear in one embodiment of the invention.

FIG. 7 illustrates one embodiment of the apparatus 10 of the invention which includes a large base 50 for docking the handle unit 12 of the invention. In this embodiment, the base 50 also includes a keypad 52 with button controls, a display 54 for visually indicating the operating parameters of the handle unit, a power cord 56 which connects the handle unit 12 to the base 50, and a docking port 58 for placing the handle unit 12 in when not in use. The keypad 52, as illustrated, typically includes control buttons for changing the power (starting, stopping and pausing) and speed (increasing, decreasing and setting) of the internal motor of the handle unit 12, as well as for setting the time of operation of the handle unit on a particular portion of the body. The display 54 typically is able to indicate data and operating parameters which can be stored in the base unit 50, and can display information such as the number of hours of use, the most frequent speeds used, the time of day, date, etc. Typically the base unit 50 is connected to an external power source (not shown) such as an electrical outlet, and the handle unit 12 receives power from the base unit 50 via the power cord 56.

While the present invention has been illustrated by the description of embodiments and examples thereof, it is not intended to restrict or in any way limit the scope of the appended claims to such detail. Additional advantages and modifications will be readily apparent to those skilled in the art. Accordingly, departures may be made from such details without departing from the scope or spirit of the invention.

What is claimed is:

1. An apparatus for rejuvenating the skin, comprising:
a. a handle unit comprising an internal motor, at least one ventilation hole for preventing overheating of the motor during operation, and a plurality of flat sides for facile gripping of the handle unit by a user; and
b. a treatment paddle adapted to be partially inserted at a distal end of the handle unit, wherein the distal end of the handle unit includes wall portions defining a connection aperture for connecting the treatment paddle thereto, and wherein the internal motor is adapted to impart motion to the connected treatment paddle.

2. The apparatus of claim 1, wherein the treatment paddle comprises:
i. a first portion for insertion into the connection aperture; and
ii. a second portion including a first surface and a second surface, the first surface having an abrasive surface formed in or attached thereto for abrading the skin, and the second surface having a surface for aid in infusing at least one topical active into the skin after treatment with the first surface.

3. The apparatus of claim 2, wherein the at least one topical active is selected from the group consisting of a cleanser, a peel agent, a toner, a moisturizer, an activator, an abrasive, a buffing material, a polishing material, a local anesthetic, and a medicament.

4. The apparatus of claim 2, where in the surface area of the first and second surfaces of the treatment paddle each ranges between about 4 cm² and about 250 cm².

5. The apparatus of claim 1, wherein the total area of the ventilation provided by the at least one ventilation hole is between about 3 mm² and about 3000 mm².

6. The apparatus of claim 1, wherein the handle unit further comprises a fan within its interior for providing increased ventilation through the ventilation holes.

7. The apparatus of claim 1, wherein the handle unit further comprises an insulating sleeve to protect the user's hand from heat generated by the handle unit.

8. The apparatus of claim 1, wherein the internal motor operates at speeds of between about 1,000 rpm and about 12,000 rpm.

9. The apparatus of claim 1, wherein the internal motor provides reciprocating or circular motion to the treatment paddle.

10. The apparatus of claim 1, wherein the handle unit is battery powered.

11. The apparatus of claim 1, wherein the handle unit is powered by an external power source, the handle unit further comprising a power cord for connection to the external power source.

12. The apparatus of claim 1, further comprising a base unit configured to provide power to the internal motor of the handle unit, the base unit comprising at least one power control button adapted for starting and stopping the internal motor of the handle unit.

13. The apparatus of claim 12, wherein the base unit further comprises:
i. a display for visually indicating operating parameters of the handle unit;
ii. at least one power control button for starting and stopping the internal motor of the handle unit;
iii. at least one speed control button for increasing and decreasing the speed of the internal motor; and
iv. at least one timer control button for setting the time of operation of the internal motor.

14. The apparatus of claim 12, wherein the handle unit further comprises a rechargeable battery, and wherein the base unit further comprises a receptacle connected to an external power source, the receptacle adapted to connect the external power source with the rechargeable battery of the handle unit when the handle unit is placed therein.

15. The apparatus of claim 12, wherein the handle unit further comprises a power cord for connection to the base unit for receiving power when the base unit is connected to an external power source.

16. A method of using an apparatus for rejuvenating the skin, comprising the steps of:
a. assessing the skin to be rejuvenated;
b. providing a treatment paddle comprising:
i. a first surface having an abrasive surface formed in or attached thereto for abrading the skin; and
ii. a second surface for aid in infusing at least one topical active into the skin after treatment with the first surface;
c. connecting the treatment paddle to a handle unit of the apparatus, the handle unit comprising:
i. an internal motor for imparting motion to the treatment paddle;
ii. a distal end having wall portions defining a connection aperture for connecting the treatment paddle thereto;
iii. at least one ventilation hole to prevent overheating thereof during operation; and
iv. a plurality of flat sides for facile gripping of the handle unit by a user; and
d. operating the apparatus while one of the surfaces of the treatment paddle is in contact with the skin to be rejuvenated, so that the treatment paddle is in moving contact with the skin and provides restructuring and regeneration of skin.

17. The method of claim 16, wherein the internal motor provides reciprocating or circular motion to the treatment paddle.

18. The method of claim 16, wherein the at least one topical active is selected from the group consisting of a cleanser, a peel agent, a toner, a moisturizer, an activator, an abrasive, a buffing material, a polishing material, a local anesthetic, and a medicament.

19. An apparatus for rejuvenating the skin, comprising:
a. a handle unit comprising an internal motor, at least one ventilation hole for preventing overheating of the motor during operation, and a plurality of flat sides for facile gripping of the handle unit by a user;
b. a base unit configured to provide power to the internal motor of the handle unit, the base unit comprising at least one power control button adapted for starting and stopping the internal motor of the handle unit; and
c. a treatment paddle comprising a first portion for insertion into the connection aperture and a second portion including a first surface and a second surface, the first surface having an abrasive surface formed in or attached thereto for abrading the skin, the second surface having a surface for aid in infusing at least one topical active into the skin after treatment with the first surface, wherein the treatment paddle is adapted to be partially inserted at a distal end of the handle unit, wherein the distal end of the handle unit includes wall portions defining a connection aperture for connecting the treatment paddle thereto, and wherein the internal motor is adapted to impart motion to the connected treatment paddle.

20. The apparatus of claim 19, wherein the base unit further comprises:
i. a display for visually indicating operating parameters of the handle unit;
ii. at least one power control button for starting and stopping the internal motor of the handle unit;
iii. at least one speed control button for increasing and decreasing the speed of the internal motor; and
iv. at least one timer control button for setting the time of operation of the internal motor.
